(19) United States
(12) Patent Application Publication
(10) Pub. No.: US 2025/0285056 A1
(43) Pub. Date: Sep. 11, 2025

(54) SYSTEM AND METHOD FOR AUTOMATIC VISUAL WORKFLOW MODEL GENERATION AND MANAGEMENT

(71) Applicant: Quantiphi, Inc, Marlborough, MA (US)

(72) Inventors: Dagnachew Birru, Marlborough, MA (US); Muneeswaran I, Mumbai (IN); Saisubramaniam Gopalakrishnan, Mumbai (IN); Kenneth Rebello, Mumbai (IN); Vishal Vaddina, Toronto (CA)

(73) Assignee: Quantiphi, Inc, Marlborough, MA (US)

(21) Appl. No.: 18/597,593

(22) Filed: Mar. 6, 2024

(51) Int. Cl. G06Q 10/0633; G06F 40/40

(52) U.S. Cl. CPC G06Q 10/0633; G06F 40/40

(57) ABSTRACT

A method for automatic visual workflow model generation and management is disclosed that utilizes multimodal inputs and user feedback. The method further comprises receiving, through a processor, descriptions using an advanced AI model, generating elaborate plans that visually organize sequential tasks. User feedback via natural language on these plans refines them, establishing connections between detailed plans and numerous sub-skills. The processor constructs a directed acyclic graph (DAG) visualizing sub-skill execution order based on the established mapping, culminating in an executable workflow model. The method further comprises seamlessly translating user descriptions into detailed plans, refine them iteratively, and generate an executable workflow model, all driven by user interactions and advanced AI techniques supporting natural language understanding and generation.

### FIELD OF TECHNOLOGY

The present disclosure generally relates to natural language understanding and generation techniques applied in workflow automation systems. Moreover, the present disclosure relates to a system and a method for automatic visual workflow model generation and management.

### BACKGROUND

The domain of workflow optimization and automation is useful across various industries, aiming to streamline processes and enhance efficiency. Manual and repetitive procedures often pose challenges, being time-consuming, prone to errors, and demanding significant resources for effective management.

Existing technologies predominantly rely on conventional software solutions that necessitate users to possess coding expertise or comprehensive knowledge of intricate system operations. Such requirements often lead to diminished efficiency due to the steep learning curve and technical complexities imposed on the users. In the pursuit of addressing such challenges, the disclosed prior art primarily revolves around software solutions reliant on traditional coding methodologies. These solutions, while functional, demand a high level of technical proficiency from users, limiting accessibility and efficiency. Moreover, these systems often lack a comprehensive natural language-based interface, hindering smooth communication between users and the system.

Further limitations and disadvantages of conventional approaches will become apparent to one of skill in the art through comparison of such systems with some aspects of the present disclosure, as set forth in the remainder of the present application with reference to the drawings.

### BRIEF SUMMARY OF THE DISCLOSURE

The present disclosure provides a method and a system for automatic visual workflow model generation and management. The present disclosure seeks to provide a solution to the existing problem of manual and complex workflow design processes. The challenge lies in providing an intuitive and efficient way for users to create, customize, and manage workflows without the need for extensive technical knowledge or expertise. An aim of the present disclosure is to provide a solution that overcomes at least partially the problems encountered in the prior art and provide an improved method and an improved system for automatic visual workflow model generation and management. The goal is to streamline the workflow creation process, enabling users to easily conceptualize and implement workflows using a visual interface, thereby enhancing productivity and reducing the barriers to entry for workflow automation.

In one aspect, the present disclosure provides a system for automatic visual workflow model generation and management. The system comprises a processor configured to receive a multimodal input via a first user interface from at least one user. The multimodal input comprises a description associated with a workflow model to be generated. The processor is further configured to cause an elaboration of the received description using a generative artificial intelligent (AI) model that supports natural language understanding (NLU) and natural language generation (NLG). The processor is further configured to generate and render an elaborate plan via a second user interface based on the elaboration of the received description. The elaborate plan is a representation of one or more sequential tasks, organized logically to depict the intended sequence and interdependencies of the workflow model. The processor is further configured to receive a first user feedback on the elaborate plan in a natural language via a chat interface linked to the second user interface. The processor is further configured to refine the elaborate plan based on the first user feedback and re-rendering a refined elaborate plan via the second user interface. The processor is further configured to establish a relationship between the refined elaborated plan and a plurality of sub-skills to obtain a plurality of mapped sub-skills. The processor is further configured to construct a directed acyclic graph (DAG) based on the received user feedback and the mapping. The constructed DAG is a visual view indicative of one or more connection between the plurality of mapped sub-skills based on an order of execution of the plurality of mapped sub-skills. The processor is further configured to generate an executable workflow model based on the constructed DAG and the first user feedback received.

The system of the present disclosure that is used for automatic visual workflow model generation and management offers several technical advantages such as below. By incorporating multimodal inputs and a chat interface for user feedback, it accommodates various forms of user interaction, enhancing accessibility and case of use. Leveraging generative AI models supporting natural language understanding (NLU) and natural language generation (NLG) streamlines the translation of user descriptions into detailed, logically organized plans. This aids in refining and visualizing complex workflows, ensuring accurate representations and reducing ambiguities. The mapping of elaborated plans to sub-skills and the subsequent construction of a directed acyclic graph (DAG) facilitate a clear understanding of task interdependencies and the order of execution. Consequently, the system generates executable workflow models that are accurate, adaptable, and align closely with user intents and feedback, thereby enhancing efficiency and user control over workflow management.

In another aspect, the present disclosure provides a method for automatic visual workflow model generation and management. The method comprises receiving, by a processor, a multimodal input via a first user interface from at least one user, the multimodal input comprising a description associated with a workflow model to be generated. The method further comprises causing, by the processor, an elaboration of the received description using a generative artificial intelligent (AI) model that supports natural language understanding (NLU) and natural language generation (NLG). The method further comprises generating and rendering, by the processor, an elaborate plan via a second user interface based on the elaboration of the received description. The elaborate plan is a representation of one or more sequential tasks, organized logically to depict the intended sequence and interdependencies of the workflow model. The method further comprises receiving, by the processor, a first user feedback on the elaborate plan in a natural language via a chat interface linked to the second user interface. The method further comprises refining, by the processor, the elaborate plan based on the first user feedback and re-rendering a refined elaborate plan via the second user interface. The method further comprises establishing, by the processor, a relationship between the refined elaborated plan and a plurality of sub-skills to obtain a plurality of mapped sub-skills. The method further comprises constructing, by the processor, a directed acyclic graph (DAG) based on the received user feedback and the mapping. The constructed DAG is a visual view indicative of one or more connection between the plurality of mapped sub-skills based on an order of execution of the plurality of mapped sub-skills. The method further comprises generating, by the processor, an executable workflow model based on the constructed DAG and the first user feedback received.

The method achieves all the advantages and technical effects of the system of the present disclosure.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not too scaled. Wherever possible, like elements have been indicated by identical numbers.

Embodiments of the present disclosure will now be described, by way of example only, with reference to the following diagrams wherein:

FIG. 1 is a block diagram of a system for automatic visual workflow model generation and management, in accordance with an embodiment of the present disclosure;

FIG. 2 is a flow diagram depicting operations of the system for automatic visual workflow model generation and management, in accordance with an embodiment of the present disclosure;

FIG. 3 is a flow diagram depicting operations to provide a second user feedback to an exemplary DAG constructed from a generated elaborate plan, in accordance with an embodiment of the present disclosure;

FIG. 4 is a flow diagram depicting operations to create a sub-skill for a workflow model, in accordance with an embodiment of the present disclosure; and

FIG. 5 is a flowchart of a method for automatic visual workflow model generation and management, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

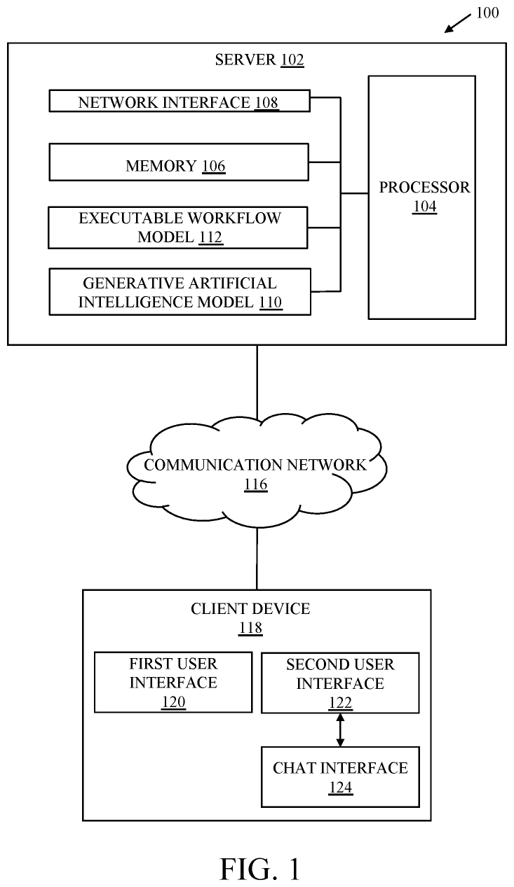

FIG. 1 is a block diagram of a system for automatic visual workflow model generation and management, in accordance with an embodiment of the present disclosure. With reference to FIG. 1, there is shown a block diagram of a system 100. The system 100 includes a server 102, a processor 104, a memory 106, a network interface 108 and a generative artificial intelligence (AI) model 110. The processor 104 is communicatively coupled with the memory 106. The processor 104 is further communicatively coupled with the network interface 108 and the generative AI model 110. Moreover, the system 100 is used to generate an executable workflow model 112 via the processor 104 using a multimodal input from a user.

In an implementation, the processor 104 and the memory 106 may be implemented on a same server, such as the server 102. In another implementations, the processor 104, the memory 106, the network interface 108 and the generative artificial intelligence (AI) model 110 may be implemented on the same server, such as the server 102. The network interface 108 is configured to communicate with the processor 104 and the memory 106. The server 102 may be communicatively coupled to a plurality of client devices, such as a client device 118, via the communication network 116. There is further shown a first user interface 120, a second user interface 122, and a chat interface 124 linked to the second user interface 122 rendered on the client device 118.

The present disclosure provides the system 100 for automatic visual workflow model generation and management from a multimodal input, where the system 100 features the first user interface 120 allowing users to input descriptions associated with workflow models using natural language or other diverse input methods. The multimodal input refers to input received from users through various modes or mediums, such as text, voice, images, or any combination thereof. In some implementations, the multimodal input comprises at least one of: a text, a code, an image, an audio and a video. In some implementations, the multimodal input includes a description associated with a workflow model to be generated. In some other implementations, the multimodal input may further include commands or instructions related to the workflow model a workflow creator/producer or a workflow consumer/end user intends to generate. In yet another implementation, the multimodal input includes the description and expected inputs required from the workflow consumer/end user to execute the workflow model. In yet another implementation, the multimodal input may include user conversations.

Incorporated within the system 100 are various interfaces, including the chat interface 124, facilitating the refinement and visualization of the multimodal input as comprehensive and structured plans. Leveraging the generative AI model 110, specifically designed to support natural language understanding (NLU) and natural language generation (NLG), the system 100 iteratively refines plans based on user feedback. The NLU refers to an AI-driven process that enables machines to comprehend and interpret human language in a way that a computer system can understand. The NLU involves the capability of a system to grasp the meaning, intent, context, sentiment, and entities conveyed in human language. The NLG refers to an AI-based process that generates human-like language or text from structured data or information stored in a machine-readable format. The NLG allows systems to convert structured data or concepts into coherent and understandable natural language sentences. Through the iterative process, the system 100 establishes intricate mappings, culminating in the formation of a Directed Acyclic Graph (DAG). The DAG visually captures the sequential relationships and dependencies among various sub-skills constituting the workflow. Ultimately, leveraging the mappings and enriched by the user feedback, the system 100 produces the executable workflow model 112. This streamlined approach significantly enhances the efficiency and user-friendliness of creating and managing workflows within diverse operational contexts.

The server 102 is configured to communicate with the client device 118 via the communication network 116. In an implementation, the server 102 may be a master server or a master machine that is a part of a data center that controls an array of other cloud servers communicatively coupled to it for load balancing, running customized applications, and efficient data management. Examples of the server 102 may include, but are not limited to a cloud server, an application server, a data server, or an electronic data processing device.

The processor 104 refers to a computational element that is operable to respond to and processes instructions that drive the system 100. The processor 104 may refer to one or more individual processors, processing devices, and various elements associated with a processing device that may be shared by other processing devices. Additionally, the one or more individual processors, processing devices, and elements are arranged in various architectures for responding to and processing the instructions that drive the system 100. In some implementations, the processor 104 may be an independent unit and may be located outside the server 102 of the system 100. Examples of the processor 104 may include but are not limited to, a hardware processor, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other processors or control circuitry.

The memory 106 refers to a volatile or persistent medium, such as an electrical circuit, magnetic disk, virtual memory, or optical disk, in which a computer can store data or software for any duration. Optionally, the memory 106 is a non-volatile mass storage, such as a physical storage media. Furthermore, a single memory may encompass and, in a scenario, and the system 100 is distributed, the processor 104, the memory 106 and/or storage capability may be distributed as well. Examples of implementation of the memory 106 may include, but are not limited to, an Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory.

The network interface 108 refers to a communication interface to enable communication of the server 102 to any other external device, such as the client device 118. Examples of the network interface 108 include, but are not limited to, a network interface card, a transceiver, and the like.

The generative AI model 110 refers to an artificial intelligence model designed specifically for the purpose of generating content or creating new data based on patterns it has learned from existing information. The generative AI model 110 may be utilized for tasks such as the NLU to interpret user input, the NLG to convert concepts into detailed plans, or other tasks relevant to automated workflow generation and management.

The executable workflow model 112 refers to a detailed plan or set of instructions that a computer system or software can interpret and execute autonomously to perform a sequence of tasks or processes. The executable workflow model 112 is a structured plan or set of instructions that a computer can interpret and act upon to automate various tasks or processes. The executable workflow model 112 may consist of a series of defined steps, tasks, or actions arranged in a logical sequence. The executable workflow model 112 incorporates the necessary information, conditions, dependencies, and instructions for the computer system to follow and execute the workflow autonomously, without requiring continuous human intervention. In some implementations, the executable workflow model 112 is configured to receive an input dataset and provide a workflow output by performing the one or more sequential tasks of the refined elaborate plan when executed. The term “input dataset” is a set of data or information provided to the workflow model as an input. The input dataset includes various forms of data such as text, numbers, images, etc. that the workflow requires to perform its tasks. The term “workflow output” refers to a result or output generated by the workflow model after performing the sequence of tasks outlined in the refined elaborate plan. It's the outcome or processed data resulting from the workflow's operations.

The storage device 114 may be any storage device that stores data and applications without any limitation thereto. In an implementation, the storage device 114 may be a cloud storage, or an array of storage devices.

The communication network 116 includes a medium (e.g., a communication channel) through which the client device 120 communicates with the server 102. The communication network 116 may be a wired or wireless communication network. Examples of the communication network 116 may include, but are not limited to, Internet, a Local Area Network (LAN), a wireless personal area network (WPAN), a Wireless Local Area Network (WLAN), a wireless wide area network (WWAN), a cloud network, a Long-Term Evolution (LTE) network, a plain old telephone service (POTS), a Metropolitan Area Network (MAN), and/or the Internet.

The client device 118 refers to an electronic computing device operated by a user. The client device 118 comprises the first user interface 120, the second user interface 122, and the chat interface 124 linked to the second user interface 122. The first user interface 120 is configured to receive the multimodal input from at least one user. The second interface 122 is configured to render an elaborate plan based on an elaboration of the received description. The elaborate plan is a representation of one or more sequential tasks, organized logically to depict the intended sequence and interdependencies of the workflow model. The chat interface 124 is linked to the second user interface 122 and is configured to receive a first user feedback on the elaborate plan. The client device 118 may be configured to obtain a user input in a natural language in a dialog box rendered over the first user interface 120 and communicate the user input to the server 102. The server 102 may then be configured to generate the executable workflow model 112. Examples of the client device 118 may include but not limited to a mobile device, a smartphone, a desktop computer, a laptop computer, a Chromebook, a tablet computer, a robotic device, or other user devices.

It should be understood by one of the ordinary skills in the art that the operations of the system 100 are explained by using a single client device. However, the operation of the system 100 is equally applicable for a number of user queries received from thousands to millions of client devices, where user requests are processed in parallel.

In operation, the processor 104 is configured to receive the multimodal input via the first user interface (UI) 120 from the at least one user. The multimodal input is provided by the workflow creator/producer. The multimodal input includes a description associated with the workflow model to be generated. The first UI 120 serves as a gateway through which the users interact with the system 100. The first UI 120 may represent any interface on the client device 118, allowing users to input data using multiple modes (i.e., multimodal) depending on their preferences or the capability of the system 100. The multiple modes may include a text, an image, an audio, or a video. For example, the first UI 120 may include, but not limited to, a graphical interface, a voice command system, or a text interface where the workflow creator/producer input descriptions or requirements related to the workflow model. In this regard, users define “fields” of input types alongside the description. The “fields” denote specific types of input expected during later stages. After the construction of the DAG and the generation of the executable workflow model 112, the provided “input” refers to actual “values” assigned to the previously described fields for testing and execution purposes. For instance, in a report generation skill, the input fields set initially may include descriptors like “topic” or “style of report,” anticipating the kind of information users may provide later. During the workflow execution, the actual values for these input fields may be specific details such as “Generative AI” or “formal,” representing the real data used in the workflow's execution.

The processor 104 is further configured to cause the elaboration of the received description using the generative AI model 110 that supports the NLU and the NLG. In some implementations, the elaboration of the received description is a process of enriching the received description provided in the natural language. In this regard, the NLU capabilities enable the system 100 to interpret and understand a natural language input provided by the users. The NLU allows the system 100 to decipher the context, semantics, and intention behind the descriptions or instructions, regardless of their complexity or variations in expression. Further, the NLG functionalities facilitate the transformation of comprehended user descriptions into structured and organized plans. This involves generating coherent sequences of tasks or steps that outline the workflow model based on the interpreted input. In addition, the utilization of the generative AI model 110 with NLU and NLG capabilities streamlines the complex process of converting free-form natural language descriptions into structured plans. The generative AI model 110 assists in breaking down intricate concepts or instructions provided by the users into understandable and actionable components. Leveraging AI-driven models streamlines the elaboration process, reducing manual intervention, and enhancing precision. This leads to more efficient and accurate planning of workflow models based on user input. Moreover, the generative AI model 110 may adapt and improve over time by learning from various inputs and user interactions. Continuous learning enables refinement in understanding user input patterns, enhancing the accuracy and adaptability of generated plans.

The processor 104 is further configured to generate and render the elaborate plan via the second user interface 122 based on the elaboration of the received description. Rendering the elaborate plan visually via the second user interface 122 offers users a clear and intuitive representation of the workflow model to be generated. Visual representations are easier to comprehend and analyze compared to textual descriptions, enhancing user understanding. Further, rendering the elaborate plan on the second user interface 122 allows multiple stakeholders or team members to access, review, and collaborate on the workflow model, promoting transparency and collaboration among users involved in the workflow design process. In addition, the visual representation aids users in making informed decisions regarding the workflow model. The users may visually inspect the elaborate plan, identify potential gaps or optimizations, and make decisions based on the presented information.

The processor 104 is further configured to receive the first user feedback on the elaborate plan in the natural language via the chat interface 124 linked to the second user interface 122. In some examples, the first user feedback is provided by the workflow consumer/end user. The chat interface 124 serves as a direct and conversational channel for the users to provide the first user feedback. A natural language input allows users to articulate their thoughts, suggestions, or concerns regarding the elaborate plan in a way that feels intuitive and conversational. By accepting the first user feedback in the natural language, the system 100 accommodates diverse user preferences and communication styles. The users may articulate specific insights, request changes, or provide detailed suggestions with clarity, facilitating an effective and easily understandable exchange. Moreover, this setup empowers users to actively participate in refining the workflow model, fostering a collaborative environment where the users feel engaged and influential in the iterative process. Overall, this natural language feedback loop streamlines communication, encourages user involvement, and contributes to the iterative enhancement of the workflow model.

In some examples, the system 100 offers users an option to provide feedback, recognizing that an initial generation may already meet their requirements. In some implementations where the user finds the generated plan satisfactory, the user feedback becomes optional. This ensures a user-friendly experience, allowing individuals to engage with the system 100 based on their specific needs. The system 100 is designed to respect user preferences, providing flexibility for those who may not require additional refinement and streamlining the workflow generation process in scenarios where the initial output aligns with expectations.

The processor 104 is further configured to refine the elaborate plan based on the first user feedback and re-rendering a refined elaborate plan via the second user interface 122. By incorporating the first user feedback into the elaborate plan, the system 100 facilitates an iterative enhancement process. Such iterative enhancement process actively considers suggestions and recommendations provided by the users, aiming to iteratively fine-tune the elaborate plan to better meet their expectations and specific requirements. The iterative refinement encourages continuous collaboration between the users and the system 100, emphasizing a user-centric approach to refining the workflow model. Moreover, the immediate re-rendering of the refined plan via the second user interface 122 offers users real-time access to updated versions. This enables users to visualize changes made in response to their feedback, promoting transparency and ensuring that their input is actively considered in the refinement process.

The processor 104 is further configured to establish a mapping between the refined elaborated plan and a plurality of sub-skills to obtain a plurality of mapped sub-skills. The mapping serves to break down the refined elaborate plan into the plurality of mapped sub-skills, effectively dividing the overall workflow into manageable, modular components. Each mapped sub-skill includes a specific task or action essential to the workflow's execution. In some implementations, each of the plurality of mapped sub-skills includes a goal for each mapped sub-skill, one or more requirements to achieve the goal, and an input and an output for each mapped sub-skill. For example, let's consider an example in the domain of e-commerce order processing.

### Mapped Sub-Skill: Automated Order Verification

Goal: The goal of the above mentioned mapped sub-skill is to verify details of incoming orders to ensure accuracy before processing.
Requirements: Access to a customer database to validate customer information and connection with an inventory management system to check product availability
Input: Order details (customer name, address, ordered items), and inventory status (product availability, quantity).
Output: Confirmation of order accuracy (customer details match, products available), and notification of any discrepancies or issues found during verification.

In this example, the “Automated Order Verification” sub-skill aims to ensure the correctness of incoming orders. To achieve this, it requires specific inputs such as order information and inventory status and produces outputs confirming the accuracy of the order or highlighting any issues encountered during verification.

By creating the mapping, the system 100 ensures a structured breakdown of the workflow model, enabling a clearer understanding and implementation of individual tasks. The division into the plurality of mapped sub-skills allows for a more organized approach to managing complex workflows. This establishes a hierarchical relationship between different components of the refined elaborate plan, outlining the sequence and interdependencies of various tasks within the workflow. Moreover, the mapping facilitates easier identification of each task's role, input-output relationships, and conditions required for execution. By structuring the workflow model into the plurality of mapped sub-skills, the system 100 promotes modularity, enabling easier maintenance, scalability, and future modifications to the workflow model. The mapping process contributes to a more comprehensible and manageable representation of the workflow, enhancing overall efficiency and adaptability of the system 100.

In some implementations, in order to map the refined elaborated plan, the processor 104 is further configured to identify the modality and the domain of the multimodal input associated with the workflow model. In order to map the refined elaborated plan, the processor 104 is further configured to select at least one of a set of predefined applications for execution of the workflow model. The predefined applications refers to a collection or catalogue of software programs, tools, or functionalities that have been previously established, configured, or designated within the system to perform specific tasks or operations. The set of predefined includes various software applications or modules designed to execute specialized actions or handle particular types of data or tasks. In addition, in order to map the refined elaborated plan, the processor 104 is further configured to determine one or more actions for execution of the workflow model based on at least one selected application. The term “one or more actions” refers to a series of specific tasks, operations, or steps that are executed or performed within a system or workflow to achieve a particular goal.

For example, imagine a scenario in a healthcare domain where a user inputs a multimodal description through the system's interface. The description details the process of analyzing patient records, medical reports, and images to generate a comprehensive medical assessment report. Firstly, to identify the modality and the domain, the processor 104 analyzes the input to recognize the modality, which may include text descriptions, images of medical reports, and even voice commands detailing patient symptoms or conditions. Based on the multimodal description, the system 104 recognizes the domain, which in this case, is healthcare or medical analysis. Further, for application selection, the processor 104 refers to a predefined set of applications suitable for healthcare analysis. For instance, the processor 104 may choose applications related to medical record processing, image analysis software, and diagnostic tools. Moreover, for determining the one or more actions based on the selected applications, the processor 104 determines the specific actions required for execution. For example: extracting structured data from textual medical records, then analyzing medical images using specialized software to detect anomalies, and then integrating data from multiple sources to create a comprehensive medical assessment report. In this example, the system 100 identifies the modality (text, images, voice) and domain (healthcare) of the input, selects suitable applications relevant to healthcare analysis, and determines the specific actions needed to execute the workflow model based on the selected applications.

In some other implementations, the processor 104 is further configured to generate prompts along with few-shot examples for each of the plurality of mapped sub-skills. The prompts include detailed instructions or queries aimed at refining the functionality and accuracy of each sub-skill. In some examples, the prompts are generated by the generative AI model 110 that supports the NLU and the NLG. The prompts are generated to achieve the respective goal of each mapped sub-skill as per the requirements defined by the sub-skill. The prompts may also be re-generated as per specific details, actions, or confirmations from the users or the processor 104. In an example, a scenario where a mapped sub-skill is a rationale generator that has a goal, one or more requirements, an input and an output as provided below:
Goal: understand the given set of facts and query, and generate a step-by-step rationale explanation
Requirements: Understand each fact and the query in depth. Each step of the explanation must cite at least one fact from the given facts.
Inputs:
facts: <−1: facts> your facts in a paragraphs format, with maximum of 10 paragraphs. Mapped with IDs
query: <−1: query> your user query here
Outputs: rationale: the generated rationale explanation

The processor 104 generated a prompt based on the goal, the requirements, the inputs, and the outputs of the mapped sub-skill. The prompt includes a system message and an instruction as provided below:

System Message: “You are a reasoning assistant. Your task is to understand a set of facts provided and then generate a step-by-step explanation in response to a given query. Each step must reference at least one fact from those provided.”
Instruction: “Given the set of facts and the user query, generate a detailed rational explanation that includes a step-by-step interpretation of the query with reference to the provided facts.”

Further, the processor 104 generated a few-shot example based on the generated prompt, as provided below.

### Facts

1. Principal is a term which has several financial meanings. The most commonly used refers to the original sum of money borrowed in a loan, or put into an investment.
2. Interest is payment from a borrower or deposit-taking financial institution to a lender or depositor of an amount above repayment of the principal sum, at a particular rate
3. A Fixed deposit (FD) is a financial instrument that provides investors with a higher rate of interest than a regular savings account.”
Query: What is the main difference between the principal amount and the interest in a fixed deposit account?
Rationale:
1. The principal amount, as referenced by Fact1, is essentially the initial amount of money borrowed or invested.
2. In contrast, interest is the amount charged on top of the principal by a financial institution, as informed by Fact2.
3. Thus, regarding a fixed deposit account, the principal is the initial amount deposited, and the interest is the additional money accrued over the deposit period at a prescribed rate, as outlined in Fact3.

In yet another implementation, the processor 104 is further configured to verify and edit the goal, the one or more requirements, and the input and the output for each mapped sub-skill based on a second user feedback received in the natural language. In other words, after the initial refinement and mapping of each sub-skill, a second phase of user feedback is solicited, i.e., the second user feedback. In some examples, the second user feedback is received in natural language via the chat interface 124 provided to the user. In some examples, the second user feedback is provided by the workflow consumer/end user. Further, the processor 104 utilizes the natural language feedback to assess and verify the accuracy, relevance, and effectiveness of the goals, the one or more requirements, the input, and the output associated with each mapped sub-skill. If discrepancies, inaccuracies, or improvements are identified through the second user feedback, the processor 104 is configured to make necessary edits or modifications to the plurality of mapped sub-skills. This may involve altering goals, adjusting requirements, refining inputs or outputs, or making other changes to ensure alignment with user expectations and efficiency of the system 100.

The processor 104 is further configured to construct the DAG based on the received user feedback and the established mapping. In some implementations, the construction of the DAG is not contingent on the received user feedback, the construction of DAG relies solely on the established mapping. The constructed DAG is a visual view indicative of one or more connection between the plurality of mapped sub-skills based on an order of execution of the plurality of mapped sub-skills. In other words, the construction process utilizes the established mapping of sub-skills to accurately represent the order of execution. Each mapped sub-skill's dependencies, prerequisites, and relationships with other tasks are visually articulated within the DAG, facilitating a comprehensive understanding of the flow and logic of the workflow model. Moreover, the DAG's acyclic nature ensures that there are no loops or circular dependencies, maintaining a clear and unambiguous sequence of operations. This visual representation aids users and system administrators in comprehending the workflow's execution flow, enabling efficient monitoring, troubleshooting, and optimization of the workflow model. The construction of the DAG provides a useful visual aid, offering a structured representation of task dependencies and order of execution within the workflow model, enhancing comprehension and facilitating effective management of the automated workflow system.

The processor 104 is further configured to generate the executable workflow model 112 based on the constructed DAG and the first user feedback received. By leveraging the information encapsulated within the constructed DAG, which outlines the sequence, dependencies, and relationships between the plurality of mapped sub-skills, the processor 104 compiles the executable workflow model 112 that is a comprehensive representation of the workflow, detailing the order of operations, conditions, and connections established through the DAG. The generated executable workflow model 112 essentially translates the abstract representation of the workflow, as visualized in the DAG, into a functional system. The functional system encapsulates the logic, instructions, and dependencies required for autonomous execution of the workflow tasks. Incorporating the first user feedback into this process ensures that the executable workflow model 112 aligns with user expectations and requirements, enabling a refined and user-centric automated workflow. Moreover, the executable nature of this model allows for seamless implementation and execution of the workflow within the system. It operates based on predefined conditions, triggers, and sequences outlined in the DAG, thereby automating and streamlining the tasks in accordance with the workflow's designed logic. In essence, the generation of the executable workflow model 112 based on the constructed DAG and the first user feedback marks the transition from conceptual planning to a functional, automated workflow system, enabling efficient and accurate task execution as per user-defined parameters and sequences.

In an implementation, the processor 104 is further configured to iteratively refine the plurality of mapped sub-skills of the executable workflow model 112 based on the second user feedback received in the natural language. The processor 104 is further configured to validate the plurality of mapped sub-skills and the interconnectedness within the executable workflow model 112 based on the second user feedback. In some implementations, in order to the generate the executable workflow model 112 based on the constructed DAG, the processor 104 is further configured to compile the refined workflow model from the associated sub-skills, interconnections, and the second user feedback.

In another implementation, the processor 104 is further configured to generate a set of test/validation examples using the workflow model. The test/validation examples are designed to validate and assess the functionality and accuracy of the workflow model. The processor 104 is further configured to validate the set of generated test/validation examples with a third user feedback received in the natural language. The third user feedback is provided by the workflow consumer/end user. Herein, the test/validation examples are specific instances or scenarios generated to assess the performance, accuracy, and functionality of a system or model. Such examples may represent different inputs or scenarios the system 100 is expected to handle. They serve as a means to verify whether the system 100 operates correctly, adheres to predefined criteria, and produces the expected outputs or results.

In some implementations, the processor 104 is further configured to validate the executable workflow model 112 by verifying if the workflow output of the executable workflow model 112 matches the description, the refined elaborated plan, and the interconnectedness of the DAG. In some other implementations, the processor 104 is further configured to validate each of the plurality of mapped sub-skills by verifying if the output of each mapped sub-skill matches the goal. In other words, validation within the executable workflow model 112 occurs at two distinct levels, ensuring the accuracy and cohesion of the entire process. At an overall workflow level, the system 100 evaluates whether the final output matches the description, ensuring alignment with the planned sequence in the DAG and confirming the interconnectedness of the plurality of mapped sub-skills. Simultaneously, at an individual sub-skill level, each mapped sub-skill logic undergoes scrutiny to guarantee precise execution within the executable workflow model 112. Such dual-level validation safeguards the accuracy and seamless operation of the executable workflow model 112.

Let's consider an example scenario a finance report system for each validation stage:

### Overall Workflow/Skill Level:

Scenario: Suppose an initial description entails creating a financial report based on specific inputs and requirements. A workflow model generated, through an elaborated plan and a DAG, aims to compile the financial report accurately.
Validation: The finance report system checks if the final output (the financial report) aligns with the initial description and if a sequence of tasks in the DAG was followed correctly. It verifies if the interconnectedness between various sub-skills within the DAG was respected.

### Individual Subskill Level:

Scenario: One subskill involves extracting data from a database based on certain criteria provided by the user.
Validation: The finance report system evaluates the subskill's performance independently. It checks if the data extraction logic aligns with the given criteria, ensuring that the subskill operates accurately within the larger workflow context.

In an example, a prompt may ask for additional verification steps in the order processing sub-skill or seek confirmation before proceeding. In this context, the prompts represent the transformation of goal and requirements into instructions that are meant to be used on the generative AI model in the future.

The disclosed system 100 is not bound to the specific implementations of the first and second user interfaces 120, 122 mentioned herein. An architecture of the system 100 is designed to be adaptable and generic, catering to diverse application requirements. While the first and second user interfaces 120, 122, along with the chat interface 124, are illustrated for clarity, it is acknowledged that alternative interfaces may be employed based on specific application needs. Flexibility of the system 100 allows for the incorporation of various interface designs and technologies beyond those explicitly mentioned, ensuring scalability and compatibility with evolving user interaction paradigms.

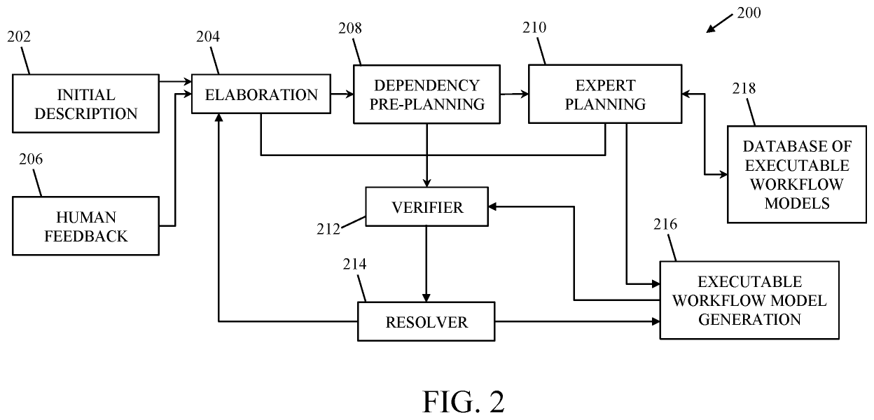

FIG. 2 is a flow diagram depicting operations of the system for automatic visual workflow model generation and management, in accordance with an embodiment of the present disclosure. FIG. 2 is described in conjunction with the elements of FIG. 1. With reference to FIG. 2, there is shown a flow diagram 200 for automatic visual workflow model generation and management. The flow diagram 200 includes a series of operations 202 to 218. The operations 202 to 218 are performed by the processor 104.

At operation 202, the multimodal input is received via the first user interface 120 from a workflow creator/producer. The multimodal input includes an initial description associated with the workflow model to be generated. In some examples, the multimodal input includes the description and the expected inputs required from the workflow consumer/end user to execute the workflow model. Then, at operation 204, the received description is elaborated using the generative AI model 110 that supports the NLU and the NLG. Further, the elaborate plan is generated and rendered via the second user interface 122 based on the elaboration of the received description. After that, at operation 206, a workflow consumer/end user reviews the elaborated plan. The first user feedback is received on the elaborated plan by the workflow creator/producer or the workflow consumer/end user via the chat interface 124. The first user feedback may be received in form of a text in the natural language, an image, a video, or an audio. Based on the first user feedback, the elaborated plan is refined and re-rendered on the client device via the second user interface 122. Further, at operation 208, the elaborated plan is mapped to the plurality of mapped sub-skills. Also, the user input modality and domain is identified and a predefined application from the set of predefined application selected and then the one or more actions are selected based on the selected predefined application. The operation 208 is also known as dependency pre-planning. Then, at operation 210, based on the dependency pre-planning or the mapping, an expert planning is done in which the elaborated plan is converted into the DAG and create interconnections between the plurality of mapped sub-skills. After that, at operation 212, there is a verifier that validate the elaborated plan generated based on the elaboration (at operation 204) of the received description and the input metadata, the mapping (operation 208) of the elaborated plan with the plurality of mapped sub-skills, the DAG (operation 210) and the interconnections of the DAG by verifying it with the initial description and feedback provided by the human expert. Similarly, the goal, the one or more requirements, the input and the output of each mapped sub-skill are also validated. The verifier may be an application or a software that compare the output with the initial description. Further, at operation 214, there is resolver that elaborate feedbacks (such as the first user feedback) received by the workflow creator/producer or the workflow consumer/end user. The elaborated feedbacks are utilized by the verifier at the operation 212 for validating different operations mentioned above. Furthermore, at operation 216, the executable workflow model 112 is generated based on the constructed DAG and the first user feedback received. then, at operation 218, the executable workflow model 112 (and other generated executable workflow models similar to the executable workflow model 112) is stored in a database for future use. It should be noted that the verifier and the resolver can be a component or module of the processor 104.

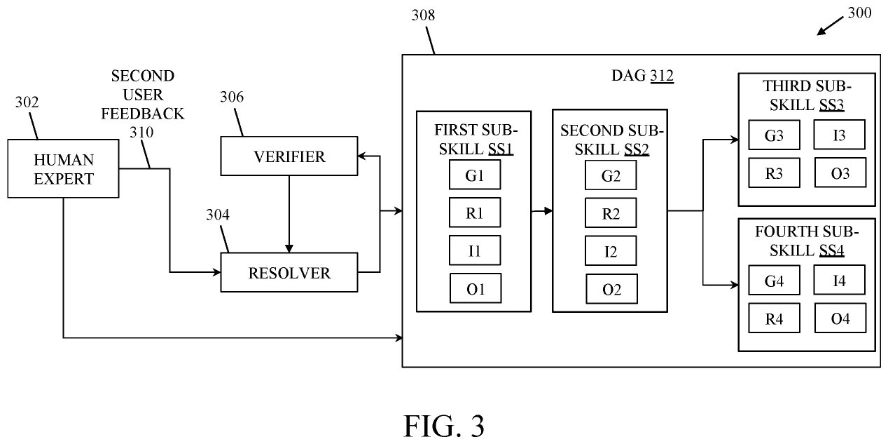

FIG. 3 is a flow diagram depicting operations to provide a second user feedback to an exemplary DAG constructed from a generated elaborate plan, in accordance with an embodiment of the present disclosure. FIG. 3 is described in conjunction with the elements of FIGS. 1 and 2. With reference to FIG. 3, there is shown a flow diagram 300 to provide a second user feedback 310 to an exemplary DAG 312 constructed from the generated elaborate plan. The flow diagram 300 includes a series of operations 302 to 308. The operations 302 to 308 are performed by the processor 104.

After the construction of the DAG 312, at operation 302, the processor 104 is configured to receive the second user feedback 310 on the constructed DAG 312 from the human expert. The human expert may be the workflow creator/producer or the workflow consumer/end user. Further, at operation 304, there is a resolver (similar to the one mentioned in the operation 214) that receives the second user feedback 310 for further elaboration for better understanding. Then, at operation 306, there is a verifier (similar to the one mentioned in the operation 212) that conducts various checks on the constructed DAG 312 to ensure its integrity and quality. The verifier further incorporates the elaborated second user feedback 310 received for further assessment and validation. The interaction between the verifier and resolver may continue iteratively in case of discrepancies or uncertainties identified during the verification process. The verifier highlights potential issues or areas of concern within the constructed DAG 312 based on certain checks. The resolver then steps in to address these concerns, clarify ambiguities, or offer further elaboration to ensure the accuracy and completeness of the DAG 312. This iterative process aims to refine the DAG 312 until it meets the required standards and aligns with the second user feedback 310 received from the human expert or user. Finally, at operation 308, the processor 104 is further configured to re-render the DAG 312 after refinement. As illustrated in FIG. 3, the DAG 312 includes 4 sub-skills i.e., a first sub-skill SS1, a second sub-skill SS2, a third sub-skill SS3, and a fourth sub-skill SS4, connected to one another in a specific manner. Each sub-skill has respective goals, requirements, inputs and outputs. For example, the first sub-skill SS1 has a goal G1, a requirement R1, an input I1, and an output O1, the second sub-skill SS2 has a goal G2, a requirement R2, an input 12, and an output O2, the third sub-skill SS3 has a goal G3, a requirement R3, an input 13, and an output O3, and the fourth sub-skill SS4 has a goal G4, a requirement R4, an input 14, and an output O4.

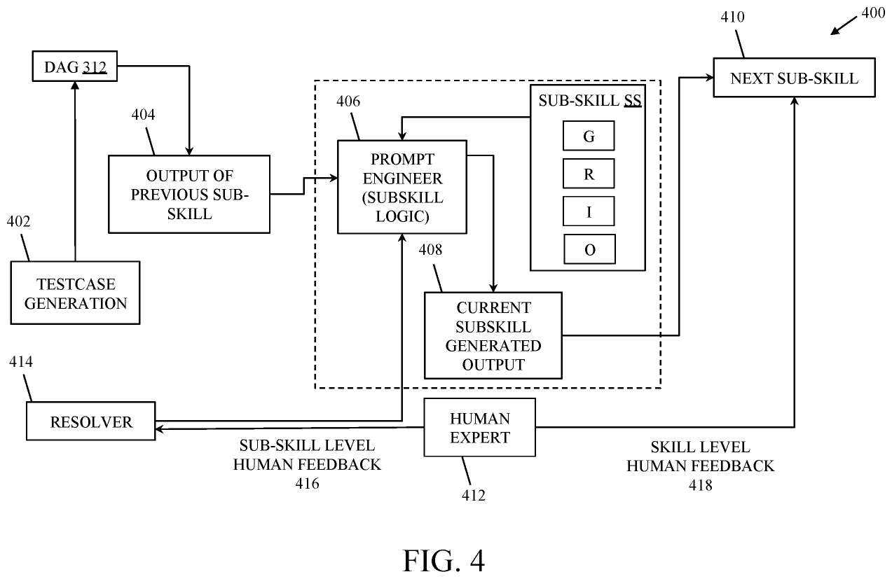

FIG. 4 is a flow diagram depicting operations to create a sub-skill for a workflow model, in accordance with an embodiment of the present disclosure. FIG. 4 is described in conjunction with the elements of FIGS. 1, 2, and 3. With reference to FIG. 4, there is shown a flow diagram 400 to create a sub-skill SS for the workflow model using the exemplary DAG 312 (shown in FIG. 3). The flow diagram 400 includes a series of operations 402 to 414. The operations 402 to 414 are performed by the processor 104.

At operation 402, the processor 104 is further configured to generate examples as test cases by connecting to internal data (via file upload, database, direct user input etc.) to support as context. This is to validate outputs of previously generated sub-skills. Then, at operation 404, the validated output of the previous sub-skill is received as input for the sub-skill SS to be generated. Further, at operation 406, the validated output of the previous sub-skill is received by a prompt engineer module. The prompt engineer module generates the prompt to generate an output O of the sub-skill SS based on the validated output of the previous sub-skill received as the input and a goal G, a requirement R, an input I of the sub-skill SS. After that, at operation 408, the processor 104 is further configured to generate the output O of the sub-skill SS. Further, at operation 410, a sub-skill subsequent to the sub-skill SS receive the output O of the sub-skill SS as an input. For example, to generate the second sub-skill SS2 (shown in FIG. 3), the output O1 of the first sub-skill SS1 (shown in FIG. 3) is received by the prompt engineer module as the input and then the output O2 of the second sub-skill SS2 is shared to generate the third sub-skill SS3 (shown in FIG. 3). Later, at operation 412, the processor 104 is further configured to receive the third user feedback from the human expert or the end user. The third user feedback includes a sub-skill level human feedback 416 and a skill level human feedback 418. The sub-skill level human feedback 416 is further elaborated by the resolver at operation 414. Further, the elaborated sub-skill level human feedback 416 is implemented by the prompt engineer module at the operation 406. This is done to refine the prompt generated based on the third user feedback. Furthermore, the skill level human feedback 418 is shared to the next sub-skill at the operation 410 for implementation and refinement of the generated workflow model.

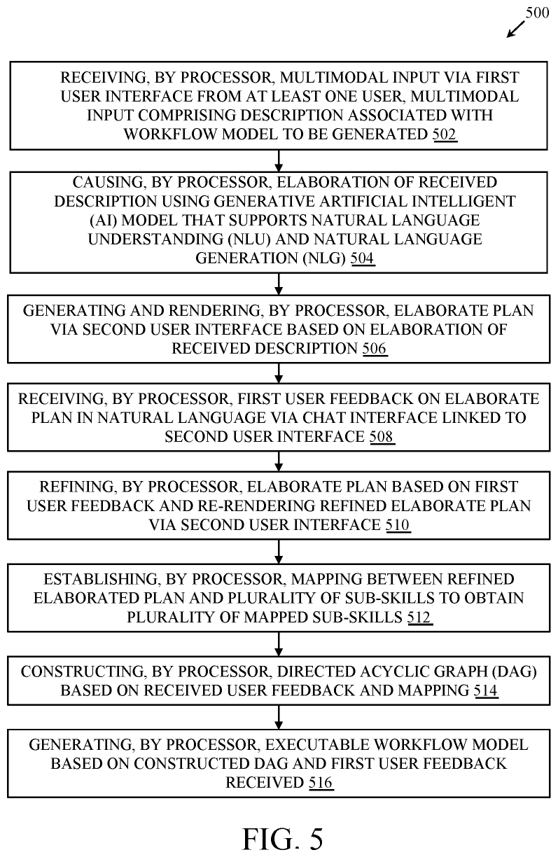

FIG. 5 is a flowchart of a method for automatic visual workflow model generation and management, in accordance with an embodiment of the present disclosure. FIG. 5 is described in conjunction with the elements of FIGS. 1 to 4. With reference to FIG. 5, there is shown a method 500 for automatic visual workflow model generation and management. The method 500 includes steps from 502 to 516.

At step 502, the method 500 includes receiving, by the processor 104, the multimodal input via the first user interface 120 from the at least one user. The multimodal input includes the description associated with the workflow model to be generated. in some examples, the multimodal input further includes the expected inputs from the workflow creator/producer or the workflow consumer/end users. Receiving the multimodal input via the first user interface 120 enhances versatility of the method 500 by accommodating various data types, including text, image, voice, or video inputs. This capability allows users, whether they are workflow creators or end-users, to provide diverse and comprehensive descriptions, contributing to a more robust and flexible workflow generation process. The inclusion of expected inputs aligns with user-centric design, ensuring that the method 500 considers and adapts to the specific demands of both workflow creators and end-users, optimizing the overall user experience. This technical feature promotes inclusivity and usability, reflecting the system's adaptability to different user roles and input modalities.

At step 504, the method 500 further includes causing, by the processor 104, the elaboration of the received description using the generative AI model 110 that supports the NLU and the NLG. By leveraging the NLU and NLG, the method 500 transforms user descriptions into elaborate plans effectively, enhancing the accuracy and depth of the subsequent workflow model. The synergy of NLU and NLG contributes to a more intelligent and context-aware workflow generation process, reflecting a key technical advantage in achieving precise and user-aligned results.

At step 506, the method 500 further includes generating and rendering, by the processor 104, the elaborate plan via the second user interface 122 based on the elaboration of the received description. The elaborate plan is a representation of one or more sequential tasks, organized logically to depict the intended sequence and interdependencies of the workflow model. By employing the elaborated plan generated by the generative AI model 110, the processor 104 constructs a detailed and logically organized plan. The elaborate plan serves as a visual representation of sequential tasks, capturing the intended sequence and interdependencies of the executable workflow model 112. The systematic arrangement enhances user comprehension and provides a clear blueprint for subsequent stages. This not only streamlines the workflow creation process but also ensures that the resultant model aligns precisely with the user's conceptualization, fostering efficiency and accuracy in workflow design.

At step 508, the method 500 further includes receiving, by the processor 104, the first user feedback on the elaborate plan in the natural language via the chat interface 124 linked to the second user interface 122. By enabling the users to provide the first user feedback and the second user feedback in the natural language, the method 500 enhances communication efficiency. This direct and intuitive feedback loop allows the users to express their thoughts, preferences, and refinements seamlessly. The integration of the chat interface 124 ensures a dynamic and interactive workflow creation process, fostering a collaborative environment between the user and the system 100. This user-centric approach not only enhances user experience but also contributes to the iterative refinement of the elaborate plan, leading to the executable workflow model 112 that is more tailored and optimized.

At step 510, the method 500 further includes refining, by the processor 104, the elaborate plan based on the first user feedback and re-rendering the refined elaborate plan via the second user interface 122. By refining the elaborate plan based on the first user feedback and subsequently re-rendering the refined elaborate plan, the method 500 ensures adaptability and responsiveness to user preferences. This iterative cycle contributes to the optimization of the executable workflow model 112, aligning the executable workflow model 112 more closely with the user's expectations and requirements. The real-time adjustments enhance the user experience, allowing for a dynamic and personalized workflow creation. This iterative refinement mechanism enhances ability of the method 500 to cater to diverse user needs, resulting in the executable workflow model 112 that is more accurate and tailored.

At step 512, the method 500 further includes establishing, by the processor 104, the mapping between the refined elaborated plan and the plurality of sub-skills to obtain the plurality of mapped sub-skills. The mapping of the refined elaborated plan includes identifying, by the processor 104, the modality and the domain of the multimodal input associated with the workflow model. Further, the mapping of the refined elaborated plan further includes selecting, by the processor 104, at least one of the set of predefined applications for execution of the workflow model. Further, the mapping of the refined elaborated plan further includes determining the one or more actions for execution of the workflow model based on at least one selected application. Identifying the modality and domain of the multimodal input enhances adaptability. Additionally, the inclusion of predefined applications and actions in the mapping process provides flexibility and customization for execution, ensuring efficient and relevant workflow models. This technical advantage allows for a more tailored and context-aware workflow model, aligning with specific user requirements and diverse applications. It enhances the overall versatility and usability of the generated workflow model through a systematic mapping process during the execution of the method 500.

At step 514, the method 500 further includes constructing, by the processor 104, the directed acyclic graph (DAG) based on the received user feedback and the mapping. The constructed DAG is a visual view indicative of one or more connection between the plurality of mapped sub-skills based on an order of execution of the plurality of mapped sub-skills. The DAG visually represents the connections between the mapped sub-skills, showcasing their order of execution. The DAG offers clarity and transparency in understanding the structure of the workflow model. Further, the DAG provides a comprehensive overview of how different sub-skills interconnect, facilitating efficient execution. The DAG construction enhances the visual representation of the workflow model, aiding users, including the workflow creators and consumers, in better grasping the logical flow and dependencies within the workflow model. This technical advantage contributes to improved user comprehension and effective management of the workflow generation process.

At step 516, the method 500 further includes generating, by the processor 104, the executable workflow model 112 based on the constructed DAG and the first user feedback received. The generating of the executable workflow model 112 based on the constructed DAG includes compiling, by the processor 112, the refined workflow model from the associated sub-skills, interconnections, and the second user feedback. By generating the executable workflow model 112 based on the constructed DAG and the first user feedback, the method 500 ensures a seamless convergence of the user input and system intelligence. This integration allows for the creation of a refined workflow model that encapsulates the user preferences and adjustments made during the feedback process. The strength of the method 500 lies in its ability to compile the refined workflow model, incorporating intricacies from associated sub-skills, interconnections, and user feedback. This synergistic approach not only enhances the accuracy of the executable workflow model 112 but also facilitates a dynamic and user-centric model, aligning closely with the user's intent and requirements.

In some implementations, the method 500 further includes generating, by the processor 104, the prompts for each of the plurality of mapped sub-skills. The prompts include detailed instructions or queries aimed at refining the functionality and accuracy of each sub-skill.

In some implementations, the method 500 further includes verifying and editing, by the processor 104, the goal, the one or more requirements, and the input and the output for each sub-skill based on the second user feedback received in the natural language. By incorporating the verifying and editing the goal, the one or more requirements, and the input and the output for each sub-skill based on the second user feedback received in the natural language, the method 500 ensures continuous refinement and optimization of the individual sub-skills, aligning them more accurately with user expectations. This dynamic verification and editing process enhances the adaptability of the overall system, allowing it to evolve based on user interactions and preferences.

In some implementations, the method 500 further includes iteratively refining, by the processor 104, the plurality of mapped sub-skills of the executable workflow model 112 based on the second user feedback received in the natural language. In some implementations, the method 500 further includes validating, by the processor 104, the plurality of mapped sub-skills and the interconnectedness within the executable workflow model 112 based on the second user feedback.

In some implementations, the method 500 further includes generating, by the processor 104, a set of test/validation examples using the workflow model and validating, by the processor 104, the executable workflow model 112 using the set of generated test/validation examples with the third user feedback received in the natural language.

In some implementations, the method 500 further includes validating, by the processor 104, the executable workflow model 112 by verifying if the workflow output of the executable workflow model 112 matches the description, the refined elaborated plan, and the interconnectedness of the DAG. In some implementations, the method 500 further includes validating, by the processor 104, each of the plurality of mapped sub-skills by verifying if the output of each mapped sub-skill matches the goal.

The method 500 introduces a paradigm shift in workflow model generation and management by integrating the multimodal inputs and the user feedbacks, revolutionizing how users interact with the system 100 (of FIG. 1). Leveraging the generative AI models 110 supporting the natural language understanding (NLU) and the natural language generation (NLG), the processor 104 translates raw descriptions into comprehensive, logically structured elaborate plans. The mapping of the elaborate plans to sub-skills and the subsequent construction of the directed acyclic graph (DAG) provide unparalleled clarity in understanding task relationships and the sequential flow of operations.

One of the key advantages lies in the system 100 adaptability to various input formats such as text, pdf documents, code, images, audio, and video, ensuring versatility across diverse user preferences and data types. Additionally, each sub-skill is meticulously defined, incorporating specific goals, requirements, inputs, and outputs. This granular detailing enhances precision and accuracy in task execution, promoting seamless interaction between users and the system 100.

The iterative refinement process, driven by the user feedback, enables continuous improvement of sub-skills and the overall workflow model. Furthermore, the method 500 facilitates extensive validation, ensuring that the generated executable workflow model precisely aligns with the initial description, refined plans, and interconnections within the DAG. These advancements collectively enhance user control, accuracy, and efficiency in generating, refining, and validating workflow models, marking a significant leap in automatic visual workflow management.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A method for automatic visual workflow model generation and management, the method comprising:
receiving, by a processor, a multimodal input via a first user interface from at least one user, the multimodal input comprising a description associated with a workflow model to be generated;
causing, by the processor, an elaboration of the received description using a generative artificial intelligent (AI) model that supports natural language understanding (NLU) and natural language generation (NLG);
generating and rendering, by the processor, an elaborate plan via a second user interface based on the elaboration of the received description, wherein the elaborate plan is a representation of one or more sequential tasks, organized logically to depict the intended sequence and interdependencies of the workflow model;
receiving, by the processor, a first user feedback on the elaborate plan in a natural language via a chat interface linked to the second user interface;
refining, by the processor, the elaborate plan based on the first user feedback and re-rendering a refined elaborate plan via the second user interface;
establishing, by the processor, a mapping between the refined elaborated plan and a plurality of sub-skills to obtain a plurality of mapped sub-skills;
constructing, by the processor, a directed acyclic graph (DAG) based on the received user feedback and the mapping, wherein the constructed DAG is a visual view indicative of one or more connection between the plurality of mapped sub-skills based on an order of execution of the plurality of mapped sub-skills; and
generating, by the processor, an executable workflow model based on the constructed DAG and the first user feedback received.

2. The method of claim 1, wherein the elaboration of the received description is a process of enriching the received description provided in the natural language.

3. The method of claim 1, wherein the executable workflow model is configured to receive an input dataset and provide a workflow output by performing the one or more sequential tasks of the refined elaborate plan when executed.

4. The method of claim 1, wherein the mapping of the refined elaborated plan comprises:
identifying, by the processor, a modality and a domain of the multimodal input associated with the workflow model;
selecting, by the processor, at least one of a set of predefined applications for execution of the workflow model; and
determining one or more actions for execution of the workflow model based on at least one selected application.

5. The method of claim 1, wherein the multimodal input comprises at least one of:
a text, a code, an image, an audio and a video.

6. The method of claim 1, wherein each of the plurality of mapped sub-skills comprises a goal of each mapped sub-skill, one or more requirements to achieve the goal, and an input and an output for each mapped sub-skill.

7. The method of claim 6, further comprising generating, by the processor, prompts along with few-shot examples for each of the plurality of mapped sub-skills, wherein the prompts include detailed instructions or queries aimed at refining the functionality and accuracy of each sub-skill.

8. The method of claim 6, further comprising verifying and editing, by the processor, the goal, the one or more requirements, and the input and the output for each sub-skill based on a second user feedback received in the natural language.

9. The method of claim 8, further comprising:
iteratively refining, by the processor, the plurality of mapped sub-skills of the executable workflow model based on the second user feedback received in the natural language; and
validating, by the processor, the plurality of mapped sub-skills and the interconnectedness within the executable workflow model based on the second user feedback.

10. The method of claim 8, wherein the generating of the executable workflow model based on the constructed DAG comprises compiling, by the processor, the refined workflow model from the associated sub-skills, interconnections, and the second user feedback.

11. The method of claim 1, further comprising generating, by the processor, a set of test/validation examples using the workflow model and validating, by the processor, the executable workflow model using the set of generated test/validation examples with a third user feedback received in the natural language.

12. The method of claim 1, further comprising validating, by the processor, the executable workflow model by verifying if the workflow output of the executable workflow model matches the description, the refined elaborated plan, and the interconnectedness of the DAG.

13. The method of claim 1, further comprising validating, by the processor, each of the plurality of mapped sub-skills by verifying if the output of each mapped sub-skill matches the goal.

14. A system for automatic visual workflow model generation and management, the system comprising:
a client device comprising:
a first user interface configured to receive a multimodal input from at least one user, wherein the multimodal input comprises a description associated with a workflow model to be generated;
a second interface configured to render an elaborate plan based on an elaboration of the received description, wherein the elaborate plan is a representation of one or more sequential tasks, organized logically to depict the intended sequence and interdependencies of the workflow model; and
a chat interface linked to the second interface configured to receive a first user feedback on the elaborate plan; and
a processor configured to:
receive the multimodal input via the first user interface from the at least one user;
cause the elaboration of the received description using a generative artificial intelligent (AI) model that supports natural language understanding (NLU) and natural language generation (NLG);
generate and render the elaborate plan via the second user interface based on the elaboration of the received description;
receive the first user feedback on the elaborate plan in a natural language via the chat interface linked to the second user interface;
refine the elaborate plan based on the first user feedback and re-render a refined elaborate plan via the second user interface;
establish a mapping between the refined elaborated plan and a plurality of sub-skills to obtain a plurality of mapped sub-skills;
construct a directed acyclic graph (DAG) based on the received user feedback and the established mapping, wherein the constructed DAG is a visual view indicative of one or more connection between the plurality of mapped sub-skills based on an order of execution of the plurality of mapped sub-skills; and
generate an executable workflow model based on the constructed DAG and the first user feedback received.

15. The system of claim 14, wherein the elaboration of the received description is a process of enriching the received description provided in the natural language.

16. The system of claim 14, wherein the executable workflow model is configured to receive an input dataset and provide a workflow output by performing the one or more sequential tasks of the refined elaborate plan when executed.

17. The system of claim 14, wherein the multimodal input comprises at least one of:
a text, a code, an image, an audio and a video.

18. The system of claim 14, wherein each of the plurality of mapped sub-skills comprises a goal of each mapped sub-skill, one or more requirements to achieve the goal, and an input and an output for each mapped sub-skill.

19. The system of claim 18, wherein the processor is further configured to verify and edit the goal, the one or more requirements, and the input and the output for each sub-skill based on a second user feedback received in the natural language.

20. The system of claim 19, the processor is further configured to:
iteratively refine the plurality of mapped sub-skills of the executable workflow model based on the second user feedback received in the natural language; and
validate the plurality of mapped sub-skills and the interconnectedness within the executable workflow model based on the second user feedback.
